(19) United States
(12) Patent Application Publication
(10) Pub. No.: US 2025/0223057 A1
(43) Pub. Date: Jul. 10, 2025

(54) PASSENGER DRONE FOR TRANSPORTING WINTER SPORTS ENTHUSIASTS WITH STRAPPED-ON WINTER SPORTS EQUIPMENT

(71) Applicant: Thomas MARSONER, London (GB)

(72) Inventor: Thomas MARSONER, London (GB)

(21) Appl. No.: 19/064,004

(22) Filed: Feb. 26, 2025

Related U.S. Application Data
(63) Continuation of application No. PCT/EP2022/074155, filed on Aug. 31, 2022.

(51) Int. Cl. B64U 10/13; A63C 19/10; B64U 60/30; B64U 60/50; B64U 101/05; B64U 101/61

(52) U.S. Cl. CPC B64U 10/13; A63C 19/10; B64U 60/30; B64U 60/50; B64U 2101/05; B64U 2101/61

(57) ABSTRACT

Passenger drone for transporting winter sports enthusiasts with strapped-on winter sports equipment, with a cargo drone, wherein a hanger can be fastened to the cargo drone, preferably in a releasable manner, wherein at least one chair, preferably at least one chairlift chair for at least one winter sports enthusiast can be fastened, in particular directly, to the hanger.

The invention relates to a passenger drone for transporting winter sports enthusiasts with strapped-on winter sports equipment, with a cargo drone, wherein a hanger can be fastened, preferably in a releasable manner, to the cargo drone. Furthermore, the invention relates to a method for transporting winter sports enthusiasts, in particular with strapped-on winter sports equipment, with at least one passenger drone.

Passenger drones, also known as autonomous flying taxis, are already known from the prior art. They are characterized by the fact that passengers can be transported allowing autonomous flight, as is known from unmanned aircraft. Airworthy models with a closed passenger cabin are already known in the prior art, such as the EHang 184 model for one passenger and the EHang 216 model for two passengers.

Patent application WO 2020/184602 A1 shows a passenger drone for rescuing people, wherein a person can be transported standing in an open hanger on a cargo drone.

The transport of winter sports enthusiasts to a higher unboarding point is usually accomplished by lifts or cable cars or chairlifts. A disadvantage of transport by lifts, cable cars or chairlifts is that the unboarding point is fixed by the mountain station. This makes it impossible to achieve an individual descent, as desired by off-piste skiers or freeriders.

An alternative is the transport of winter sports enthusiasts by helicopter, a process also known as heliskiing/snowboarding. In this case, a pilot takes one or more winter sports enthusiasts to a desired unboarding point, often a summit. The disadvantage of this method is the high costs, which are caused, among other things, by the high fuel consumption and the need for a pilot. In addition, heliskiing/snowboarding pollutes the environment due to loud engine noise and helicopter exhaust fumes. Therefore, heliskiing/snowboarding is prohibited in many areas, especially in most areas of the Alps.

These disadvantages can be partially avoided by using passenger drones to transport winter sports enthusiasts. Patent application WO 2019/209132 A1 shows the use of a passenger drone with a closed cabin in the mountains, wherein in particular the use for winter sports enthusiasts for off-piste skiing or freeriding is disclosed.

The disadvantage, however, is that unboarding is difficult in impassable, steep and/or exposed terrain, such as on narrow peaks or ridges or in steep gullies, where landing the passenger drone is not possible. Winter sports enthusiasts therefore often have to disembark from a flying passenger drone. Since there is no space in passenger drones to strap on winter sports equipment such as skis or snowboards, winter sports enthusiasts must get out without strapped-on winter sports equipment and strap on the winter sports equipment in the field. This represents a significant safety risk for winter sports enthusiasts in impassable, steep and/or exposed terrain. Boarding the passenger drone is also difficult.

It is an object of the present invention to avoid these disadvantages. In particular, it is an object of the present invention to provide a passenger drone which enables a safe unboarding on exposed terrain.

Therefore, in a passenger drone according to the invention, at least one chair, preferably at least one chairlift chair, for at least one winter sports enthusiast can be fastened to the hanger.

A method according to the invention provides for the transport of winter sports enthusiasts, in particular with strapped-on winter sports equipment, with at least one such passenger drone.

This means that a winter sports enthusiast can be transported with, at least partially, strapped-on winter sports equipment, similar to a chairlift. This allows for safe unboarding from the passenger drone on steep terrain. It is also possible to jump out of the drone in particularly inaccessible places.

In particular, the at least one chair can be attached directly to the hanger. The at least one chair cannot be fastened to a cabin attached to the hanger. In particular, it is a chairlift on which a winter sports enthusiast can be transported with winter sports equipment strapped on.

In one exemplary embodiment, it is provided that a safety bar is arranged and/or fastened to the at least one chair and/or to the hanger. This protects a winter sports enthusiast from falling out of the chair during transport. It is preferably provided that a footrest is arranged on the safety bar. A winter sports enthusiast can use it to support his feet, especially his strapped-on winter sports equipment.

The safety bar can be designed to be pivotable and thus have an open position and a closed position. This allows a winter sports enthusiast to get in and out with the safety bar open, while the safety bar can be closed during a passenger drone flight.

The footrest can also be attached directly to the chair and/or the hanger.

The hanger may have a curved shape, at least in sections. This means that the hanger can also be used for a chair on a chairlift.

The chair and/or the hanger can be made at least partially, preferably mostly, from fiber-reinforced plastic, in particular from carbon fiber-reinforced plastic. This keeps the weight of the passenger drone low, while at the same time achieving a stable design.

In a preferred embodiment, the seating area of the at least one chair is at least partially open to the outside. In particular, the chair is not arranged in a closed capsule or cabin. Rather, the seating area of the at least one chair can be at least partially surrounded by rods, wherein the rods can be, for example, parts of the chair, the safety bar or the hanger.

In a further embodiment, the at least one chair can be partially closed by at least one openable, preferably pivotable and/or partially transparent, protective hood. It is preferably provided that the seating area of the at least one chair is at least partially open to the outside when the protective hood is closed and when it is open. This provides winter sports enthusiasts with simple protection from wind and weather. The feet with the winter sports equipment strapped on could protrude outwards and in particular be placed on a footrest because the seating area of the at least one chair is at least partially open to the outside even when the protective hood is closed.

Another positive effect of the protective hood is the protection of winter sports enthusiasts sitting on at least one chair from the so-called prop wash. Prop wash is the airflow generated by the running rotor, which can be particularly strong during start-up.

For the two embodiments of the previous two paragraphs, a typical chairlift seat can be used, which often have opening protective hoods.

The protection of winter sports enthusiasts from the prop wash of the rotors can be achieved additionally or alternatively in other ways. In general, at least one cover can be arranged between the at least one chair and at least one, preferably all, rotors of the cargo drone to protect the winter sports enthusiasts sitting on the at least one chair

The cover is preferably at least partially transparent.

The cover is preferably curved towards the at least one chair, particularly preferably in a hemispherical shape. This means that a winter sports enthusiast can, for example, be at least partially enclosed, thus providing good protection against prop wash.

As stated above, the cover can be designed as an opening protective hood, as is often provided on chairlift seats.

A parking device can preferably be arranged on the hanger and/or on the chair, wherein the parking device extends into an area under the at least one chair and/or the hanger. This allows the chair and/or the hanger or the entire passenger drone to be parked. The cargo drone can thus be uncoupled. The cargo drone can also be docked and switched off.

Preferably, the parking device has at least one skid and/or at least one wheel. A skid allows the passenger drone or the chair and/or the hanger to be moved in the snow. A wheel allows the passenger drone or the chair and/or the hanger to be moved on snow-less surfaces.

It can also be intended to use the parking device as a footrest. For this purpose, a cross brace can be provided on the parking device.

In one exemplary embodiment, the cargo drone has a connecting part, wherein the hanger can be fastened to the cargo drone with the connecting part.

In one exemplary embodiment, the hanger has a fastening device for connection to the cargo drone at the end opposite the at least one chair.

By means of the fastening device, the hanger can be attached to the cargo drone, preferably detachably. Various fastening methods are conceivable.

A joint can be arranged between the cargo drone and the hanger. Preferably, the joint is designed as a hinge, pivot bearing, universal joint or ball joint. This allows the hanger to hang straight down despite the cargo drone being at an angle, for example when flying.

Such a joint can be arranged on the fastening device and/or on the connecting part and/or on the hanger.

The joint can be designed to be lockable. For example, it can be designed to lock the joint when the passenger drone lands so that a switched off cargo drone does not tip over. The joint can be locked electronically and/or mechanically and automatically and/or manually.

The joint can be designed with dampening. This can reduce or prevent vibration of the hanger while the passenger drone is flying.

A weight detection device can be arranged between the cargo drone and the hanger, preferably wherein the weight detection device has strain gauges. This can be used to measure whether one and/or more winter sports enthusiasts are sitting in the passenger drone's seat. It can also be detected whether the at least one winter sports enthusiast has disembarked.

It can be provided that the hanger can be fastened to the cargo drone via a rope section and/or a rail. This means that fastening devices that are commonly used on chairlifts can be used to attach the hanger to the cargo drone.

The hanger can be fastened to the cargo drone via a clamp, preferably wherein the clamp is held in a closed position by means of a spring and/or can be moved from a closed position to an open position by means of an actuating lever. The clamp can be designed according to a design commonly used on chairlifts. By operating the operating lever, the hanger can be released from the cargo drone. In particular, it is intended that the clamp can be attached to the cargo drone via a rope section.

It can also be provided that the clamp can be hooked into a rail, just as usual clamps on chairlifts are guided into rails in the station.

In one exemplary embodiment, the cargo drone has at least one, preferably four, six, eight or sixteen, rotor(s), wherein the at least one rotor can preferably be fastened to at least one cantilever, and wherein particularly preferably exactly one and/or exactly two rotors can be fastened to each cantilever. The cargo drone can therefore be designed as a multicopter.

Various shapes of cantilevers are conceivable, with all rotors preferably being arranged on an imaginary circle. In particular, a plus configuration is conceivable in which one rotor is arranged at the front in the forward flight direction. A cross configuration is also conceivable, in which two rotors are arranged at the front in the forward flight direction.

It can be provided that two propellers are mounted on each cantilever and can be operated coaxially in opposite directions.

The cargo drone can have at least one electric motor, wherein the at least one electric motor can be supplied with electrical energy from at least one accumulator. It can be provided that multiple electric motors can be supplied with electrical energy from one accumulator. However, it can also be provided that one accumulator is assigned to each electric motor.

It is particularly advantageous that one rotor or two coaxial rotors can be driven by one electric motor. The cargo drone can thus be controlled by different speeds of the electric motors without a transmission gear and tilting rotors.

In one embodiment, the cargo drone has at least one sensor.

The cargo drone can have at least one position sensor, in particular at least one pressure sensor. This can be used, for example, to determine the height of the cargo drone.

The cargo drone can have at least one motion sensor, in particular at least one gyro sensor and/or acceleration sensor. With a gyro sensor, the rotation of the cargo drone can be determined. With an acceleration sensor, the acceleration of a drone can be determined.

The cargo drone can have at least one environmental sensor, in particular at least one camera, at least one LIDAR system and/or at least one RADAR system. This allows avoiding obstacles such as trees, rocks, masts or the ground.

In one exemplary embodiment, the cargo drone has a control unit for controlling at least one electric motor, wherein the control unit can be connected to sensors. The control unit can process sensor signals and use a control algorithm to control the engine speeds so that the cargo drone flies stably floating in the air, flies while moving and/or performs another maneuver.

The passenger drone may have at least one communication unit, preferably wherein the communication unit has an antenna for communication, wherein electromagnetic signals can be sent
from a satellite, in particular a navigation satellite, and/or
to and from a mobile and/or stationary transmitting unit, in particular via a mobile network, and/or received by the same.

Electromagnetic signals from a satellite, in particular a navigation satellite, can be used to determine the position of the passenger drone using a navigation satellite system such as GPS.

Electromagnetic signals can also be received to and from a mobile transmitting unit. If a winter sports enthusiast wears a mobile transmitter unit, such as a smartphone or smartwatch, he or she can give instructions to the passenger drone. The passenger drone can also transmit its location or its free/occupied status to a winter sports enthusiast.

Electromagnetic signals can also be transmitted via a stationary transmitter unit. Voice messages and/or data, such as maps and/or control instructions, can be sent via a mobile network.

In one embodiment, a first communication unit is provided in the cargo drone and a second communication unit is provided on the hanger and/or on the at least one chair. This allows at least one electrical signal to be sent between the first communication unit and the second communication unit, for example to send status messages from the cargo drone to the winter sports enthusiast or control instructions from the winter sports enthusiast to the cargo drone. The first and/or the second communication unit can also be designed to communicate with third parties.

In one exemplary embodiment, an operator unit is arranged on at least one chair and/or on the hanger, wherein the operator unit has a display and/or actuating elements, preferably wherein the cargo drone can be controlled by means of the operator unit. In particular, the operator unit can communicate with the control unit via the first and second communication units.

Furthermore, an intercom system can be arranged on at least one chair and/or on the hanger system. This allows a winter sports enthusiast to communicate with a third party, wherein the third party can in particular be a base station and/or a winter sports enthusiast in another passenger drone.

Communication can take place via the communication unit, in particular the first communication unit. For this purpose, signals can be sent between the communication unit and the operator unit, preferably wirelessly. This makes it possible, for example, for the winter sports enthusiast to control the cargo drone.

As already mentioned, a method according to the invention provides for the transport of winter sports enthusiasts, in particular with strapped-on winter sports equipment, with at least one such passenger drone.

An exemplary embodiment of the method according to the invention comprises at least one of the following steps:
accommodating at least one winter sports enthusiast in the at least one chair,
transporting the at least one winter sports enthusiast from at least one first base station to an unboarding point, preferably higher than the at least one first base station, by, preferably autonomous, flying of the passenger drone,
dropping off at least one winter sports enthusiast at an unboarding point,
returning the passenger drone to the at least one first base station or to at least one second base station.

The base station may include a charging station for charging the passenger drone, in particular the accumulators.

The accommodation of at least one winter sports enthusiast in the at least one chair can take place in the at least one first base station. It may be provided that the first base station can only be accessed with a ski pass, wherein an access system can be used, for example.

It may be provided that when at least one winter sports enthusiast is being picked up, the hanger with the at least one chair is separated from the cargo drone, and the cargo drone is only connected to the hanger before the at least one winter sports enthusiast is transported. The winter sports enthusiasts can be picked up by a cargo drone and take their seats beforehand.

The following steps may be provided:
picking up at least one winter sports enthusiast in at least one valley station, wherein the harness is attached to the cable of a chairlift,
transporting the at least one winter sports enthusiast to at least one first base station, preferably higher than the valley station, by the chairlift,
decoupling the hanger from the chairlift cable,
fastening the hanger to the cargo drone.

This means that only the last transport section, preferably in difficult terrain, can be accomplished with a cargo drone.

The hanger with the at least one chair can be provided in the at least one first base station hanging and/or standing on the ground to pick up at least one winter sports enthusiast. If the hanger is provided in a hanging position, it can be provided that the hanger is suspended in a stand with the fastening device. If the hanger is provided in a standing position, it can be provided that the hanger is placed on the parking device.

It may be provided that the passenger drone remains within a predefined flight corridor when transporting the at least one winter sports enthusiast and/or when returning. For this purpose, a navigation satellite system, in particular GPS, of the passenger drone can be used. This prevents the passenger drone from straying into dangerous areas, such as areas with air traffic.

In an exemplary embodiment, it is provided that the passenger drone, when transporting the at least one winter sports enthusiast and/or when returning, at least in sections,
flies autonomously, and/or
is controlled by a base station, and/or
is controlled by the at least one winter sports enthusiast.

Preferably, the passenger drone flies autonomously, for example based on a map. For example, the passenger drone can be controlled by the winter sports enthusiast before disembarkation and/or in emergency situations. Likewise, in emergency situations, the passenger drone can be controlled from the base station.

When at least one winter sports enthusiast is dropped off at the unboarding point, it can be recorded whether the drop-off of the at least one winter sports enthusiast has taken place. Registration can preferably take place
automatically, in particular by measuring a weight detection device, and/or
by manual indication of at least one winter sports enthusiast, and/or
by remote indication from the base station

The weight detection device can measure the decreasing load weight of the passenger drone and conclude that the at least one winter sports enthusiast has been dropped off.

The manual indication of the at least one winter sports enthusiast can be carried out via the actuating device and/or a mobile transmitting unit, in particular via the first communication unit.

Remote indication from the base station can be done via the communication unit.

In an exemplary embodiment, an autonomous return of the passenger drone to the at least one first base station or to at least one second base station can be initiated by registering the drop-off of the at least one winter sports enthusiast. For example, the passenger drone can automatically return after at least one winter sports enthusiast has jumped off.

It may be provided that the passenger drone follows the at least one winter sports enthusiast before or during the return. The passenger drone can, for example, take a video of the winter sports enthusiast. Preferably, the passenger drone sends a warning signal to the base station in the event of an emergency. An emergency could be, for example, an avalanche and/or a fall of a winter sports enthusiast. An emergency can be detected automatically from the base station, in particular by means of artificial intelligence and/or via the camera on the passenger drone.

Particularly preferably, the at least one winter sports enthusiast can summon the passenger drone away from the at least one base station, preferably by means of a mobile transmitting unit. As a result, the at least one winter sports enthusiast can be recorded away from the at least one base station. This can also be used in an emergency, for example if the winter sports enthusiast can no longer continue skiing, either due to an injury or because the descent route is blocked by a cliff.

This function can also be used on a planned basis, for example when a downhill route is not completely passable because, for example, a cliff is blocking the way. This means that the upper part of the descent route can be traveled and then a planned re-ascent can take place with the passenger drone.

Of course, the passenger drone, like a chairlift, can also be used in summer. The passenger drone can also be used for non-sporting purposes.

For example, the passenger drone can be used as a rescue drone. A person in need of rescue can be picked up by the passenger drone. If the drone is designed as a two-seater, a first responder can be transported to the person to be rescued using the passenger drone. It may also be provided that instead of a seat for the second person, a holder for an akia or a stretcher is provided.

This means that first responders no longer have to climb to the scene of the accident, which saves time and minimizes the risk to the injured person. The risk for a first responder is also minimized, as he or she does not have to climb into potentially dangerous areas.

The advantage of using a passenger drone over a helicopter is that passenger drones can fly close to the ground even in low visibility, even in rugged terrain that is dangerous for helicopters. Passenger drones always find their way back to the base station thanks to the autonomous flight function.

Further details and advantages of the invention are explained in more detail below based on the description of the figures with reference to the drawings. In particular:

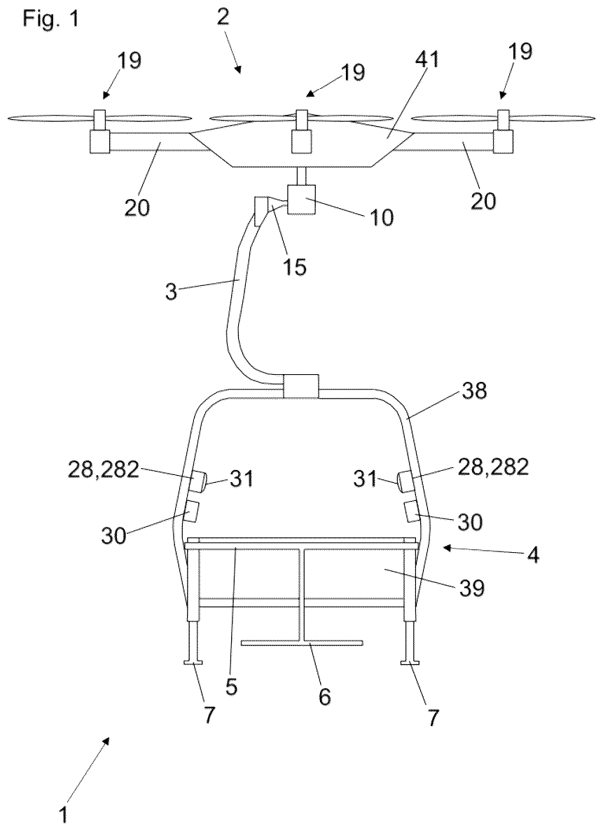

FIG. 1 shows a passenger drone in front view,

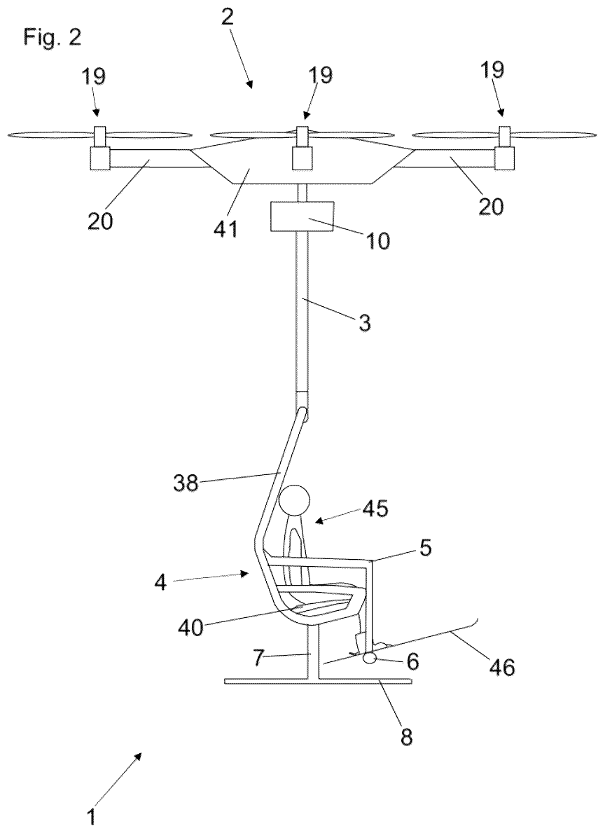

FIG. 2 shows a passenger drone in side view with winter sportsman,

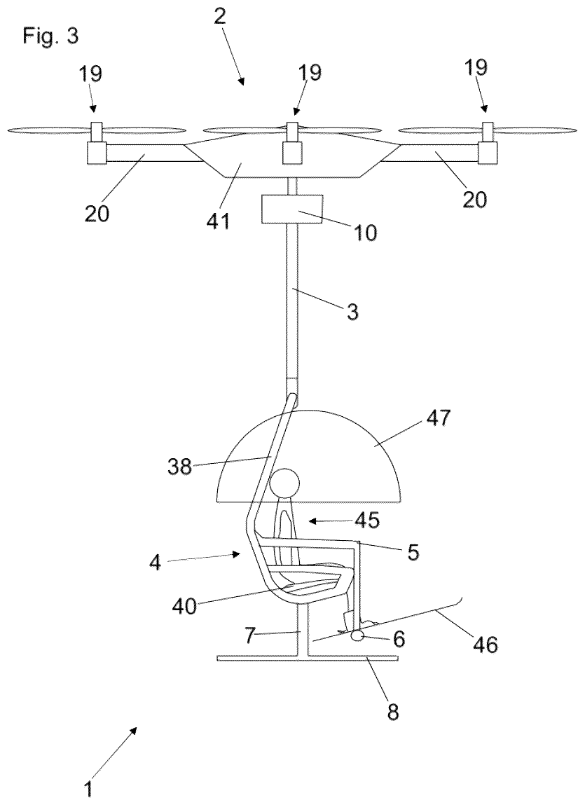

FIG. 3 shows a passenger drone in side view with winter sportsman and cover

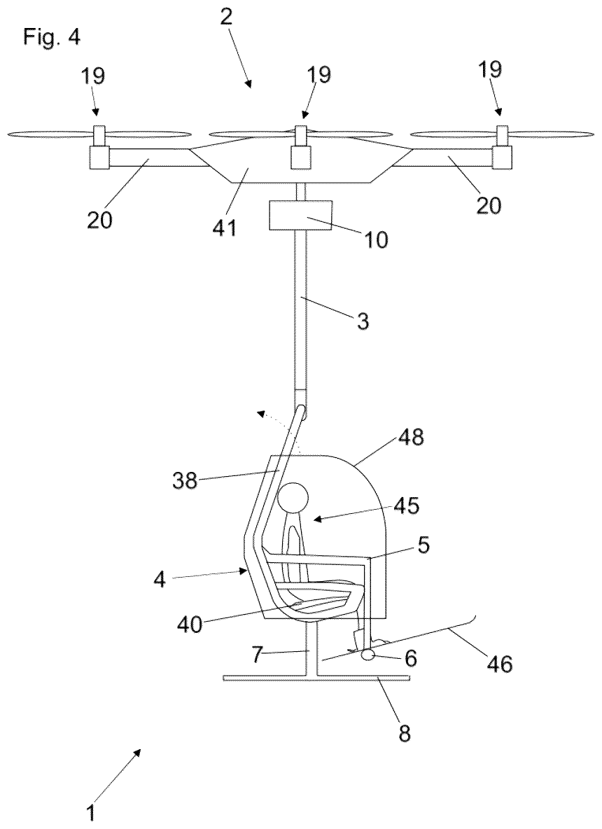

FIG. 4 shows a passenger drone in side view with winter sportsman and protective hood

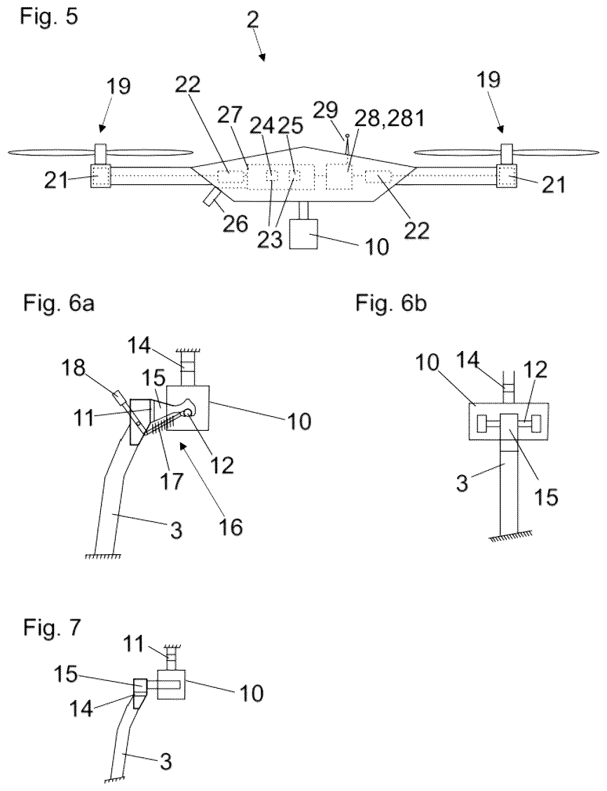

FIG. 5 shows a cargo drone with devices inside,

FIGS. 6a, b show a connection of the cargo drone with the hanger,

FIG. 7 shows an alternative exemplary embodiment of the connection of the cargo drone with the hanger,

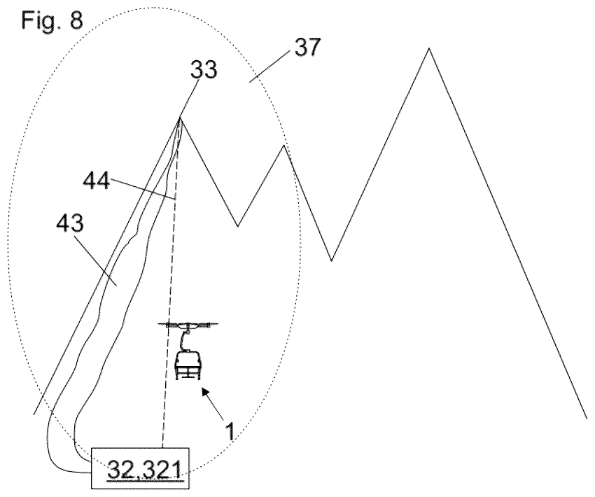

FIG. 8 shows a method for transporting a winter sports enthusiast with a passenger drone,

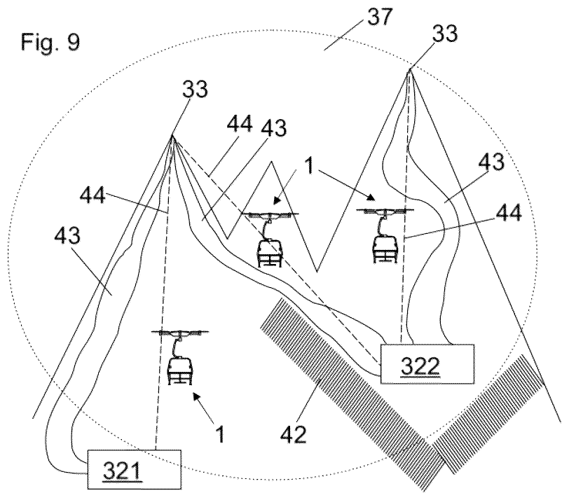

FIG. 9 shows a method for transporting a winter sports enthusiast with a passenger drone with two base stations, and

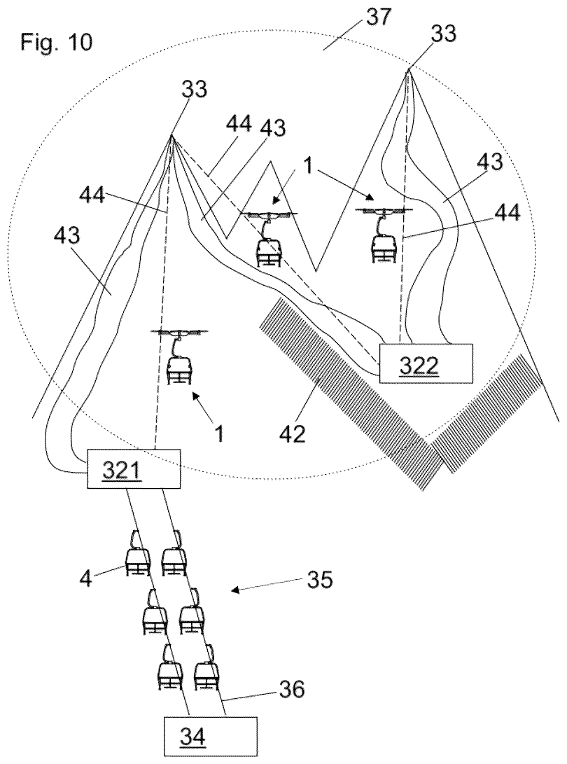

FIG. 10 shows a method for transporting a winter sports enthusiast with a passenger drone in combination with a chairlift.

FIG. 1 and FIG. 2 show a passenger drone 1 for transporting winter sports enthusiasts with strapped-on winter sports equipment, with a cargo drone 2, wherein a hanger 3, is fastened to the cargo drone 2, preferably in a releasable manner. A chair 4 for at least one winter sports enthusiast is fastened to the hanger 3.

FIG. 1 shows a front view and FIG. 2 a side view of the passenger drone 1. FIG. 2 also shows a winter sports enthusiast 45 with strapped-on winter sports equipment 46, in this case shaped as skis, sitting on the chair 4.

In the exemplary embodiment, the chair 4 is designed as a double chair for two winter sports enthusiasts. This can essentially be a typical chairlift chair.

The seating area of the at least one chair 4 is open to the outside, in particular no capsule is provided in which the chair 4 would be arranged. The winter sports enthusiast sitting in the seating area is only surrounded by an air-permeable rod system.

A safety bar 5 is arranged on at least one chair 4, and a footrest 6 is also arranged on the safety bar 5. A winter sports enthusiast 45 can rest his foot, or if necessary his winter sports equipment 46, on the footrest 6. The safety bar 5 is pivotally mounted so that it can be pivoted from a closed position, as in FIG. 1 and FIG. 2, into an open position. In an open position, a winter sports enthusiast 45 can get in and out.

The hanger 3 has a curved shape, at least in sections. The curved shape of the hanger 4 is typical for hangers of chairlifts, where this shape is necessary due to the supports. The hanger 3 and the chair 4 can be shaped like a conventional chairlift.

The chair 4 has a chair rod 38 which is connected to the hanger 3. In the lower area of the chair rod 38, a seat 40 and a backrest 39 are arranged, which form the actual seat support for the winter sports enthusiast 45.

The chair 4 and/or the hanger 3 can be made at least partially, preferably mostly, from fiber-reinforced plastic, in particular from carbon fiber-reinforced plastic. This keeps the weight of the passenger drone 1 low.

A parking device 7 is arranged on the chair 4, wherein the parking device 7 extends into an area under the at least one chair 4 and the hanger 3. The parking device 7 has at least one skid 8. This allows the passenger drone 1 to be moved in the snow. It can also be provided that the parking device 7 has at least one wheel, but this is not shown in the figures. The parking device 7 is attached here to the chair rod 38.

The cargo drone 2 has a connecting part 10, wherein the hanger 3 can be fastened to the cargo drone 2 with the connecting part 10. The hanger 3 has a fastening device 15 for connection to the cargo drone 2 at the end opposite the at least one chair 4. Further details on the fastening of the hanger 3 to the cargo drone 2 can be seen in FIG. 6a, b and FIG. 7.

FIG. 3 shows the passenger drone 1 in the view from FIG. 2 with a cover 47, which is arranged between the rotors 19 of the cargo drone 2 and the at least one chair 4 for protecting the winter sports enthusiast 45. This allows the winter sports enthusiast 45 to be protected from prop wash (air flow of the rotors 19).

In this exemplary embodiment, the cover 47 is attached to the chair 4, although other attachment points, in particular an attachment point on the hanger 3, are also possible.

The cover 47 has a partially spherical shape and is curved towards the at least one chair 4. The cover 47 is partially transparent so that the winter sports enthusiast 45 has visibility.

The cover 47 is open at the bottom so that the winter sports enthusiast 45 can get out of the chair 4 without unbuckling the winter sports equipment 46.

The cover 47 can also be mounted movably, in particular pivotably, at the fastening point.

FIG. 4 shows the passenger drone 1 in the view from FIG. 2 or 3 with an openable protective hood 48. Protective hoods 48 of this type are already known in chairlifts in order to protect winter sports enthusiasts 45 from wind and weather. In this case, the protective hood 48 has the additional advantage of protection against prop wash, since the protective hood 48 is also arranged between the rotors 19 and the chair 4 in the closed state.

Before unboarding, the winter sports enthusiast 45 can swing the protective hood 48 into an open position and climb down or jump off the chair 4 with the winter sports equipment 46 strapped on.

Despite the protective hood 48 from FIG. 4 or the cover 47 from FIG. 3, the seating area of the at least one chair 4 is at least partially open to the outside. In particular, the winter sports enthusiast 45 can arrange the winter sports equipment 46 outside the protective hood 48. This allows the winter sports enthusiast 45 to leave the winter sports equipment 46 strapped on and to dismount or jump off more easily in rough, steep terrain.

FIG. 5 shows a cargo drone 3 with devices inside the cargo drone 3 in a sectional view. The cargo drone 2 has a base body 41 with a housing, four cantilevers 20 pointing outwards from the base body and four rotors 19 each attached to the outer ends of the cantilevers.

The axes of the rotors 19 are located on an imaginary circle (also shown in FIG. 1 and FIG. 2). The cargo drone 2 is designed here in a plus configuration. This means that with four rotors 19, one rotor 19 is arranged at the front in the forward flight direction, two rotors 19 are arranged centrally on the sides and one rotor 19 is arranged at the rear.

Inside, the cargo drone 2 has one electric motor 21 for each rotor 19, wherein the electric motors 21 are supplied with electrical energy by at least one accumulator 22. An electric motor 21 associated with a rotor 19 is arranged coaxially with the rotor 19. This means that no gearbox is necessary and the rotor 19 can be driven directly by the electric motor 21.

The cargo drone 2 can be controlled by means of a control unit 27 for controlling at least one electric motor 21. The control unit 27 can be connected to sensors 23. Based on the input of the sensors 23, the speed of the electric motors 21 can be adjusted for control.

The sensors 23 of the cargo drone 2 comprise at least one position sensor 24, in particular at least one pressure sensor, with which the height can be determined.

The sensors 23 of the cargo drone 2 also include a motion sensor 25, in particular at least one gyro sensor and acceleration sensor, with which a rotation and an acceleration can be measured. A motion sensor can also be used for an inertial navigation system, with which the relative position of the cargo drone 2 can be determined.

The sensors 23 of the cargo drone 2 also comprise at least one environmental sensor 26, in particular at least one camera, at least one LIDAR system and/or at least one RADAR system, with which the environment can be perceived. This can be used, for example, to detect obstacles.

The passenger drone 1 also has a communication unit 28, wherein the communication unit 28 has an antenna 29 for communication. Electromagnetic signals from a satellite, in particular a navigation satellite, and/or to and from a mobile and/or stationary transmitting unit, in particular via a mobile radio network, can be sent and received via the antenna 29. The absolute position of the passenger drone 1 can be determined using signals from a navigation satellite, for example using GPS. In addition, communication can be carried out with a winter sports enthusiast 25 or a base station 32.

A first communication unit 281 is provided in the cargo drone 2. This can be seen in FIG. 5.

A second communication unit 282 is provided on at least one chair 4, as can be seen from FIG. 1. Here, the second communication unit 282 is attached to the chair rod 38 at head height of a winter sports enthusiast 45. An intercom system 31 is also installed on the second communication unit 282, by means of which a winter sports enthusiast 45 can receive and send voice messages.

An operator unit 30 is also arranged on the chair rod 38, wherein the operator unit 30 has a display and/or actuating elements. The cargo drone 2 can be manually controlled by the winter sports enthusiast using the operator unit 30. The status of the cargo drone 2, such as speed, altitude or position, can be shown on the display. A map can also be displayed.

Signals can be sent, preferably wirelessly, between the communication unit 28, preferably the first communication unit 281, and the operator unit 30. This means, for example, that the cargo drone 2 can be controlled by the winter sports enthusiast 45.

FIGS. 6a, 6b and 7 show the connection of the cargo drone 2 to the hanger 3, in particular different views of the connecting part 10 of the cargo drone 2 and the fastening device 15 on the hanger 3 for connecting the cargo drone 2 to the hanger 3.

FIG. 6a shows a front view of an exemplary embodiment. In this case, the hanger 3 can be attached to the cargo drone 2 via a rope section 12. The rope section can also be designed as a rod or tube with similar dimensions.

The hanger 3 can be fastened to the cargo drone 2 via a clamp 16, preferably wherein the clamp 16 is held in a closed position by means of a spring 17 and/or can be moved from a closed position to an open position by means of an actuating lever 18. In FIG. 6a, the clamp 16 is shown in the closed position.

FIG. 6b shows a side view of the embodiment in FIG. 6a, wherein the clamp 16 is not shown. However, the rope section 12, which is attached to the connecting part 10, is clearly visible.

In FIGS. 6a and 6b, a weight detecting device 14 is arranged between the cargo drone 2 and the hanger 3. Here, the weight detecting device is arranged in the upper area of the connecting part 10. For example, it can use strain gauges to measure the weight of the hanger 3 and the chair 4 together with the load, i.e. the winter sports enthusiasts. This can be used to determine whether and how many winter sports enthusiasts are sitting on chair 4.

A joint 11 is attached to the hanger 3, in particular to the fastening device 15. Thus, the hanger 3 is pivotally mounted relative to the cargo drone 2, whereby the hanger 3 and the chair 4 are arranged essentially vertically even when the cargo drone 2 is inclined, i.e. when the cargo drone 2 is in forward flight. The joint 11 can be designed to be dampened in order to avoid excessive swinging of the hanger 3 during flight. The joint 11 is designed here as a pivot bearing.

FIG. 7 shows an alternative exemplary embodiment of a connection of the cargo drone 2 with the hanger 5, in particular of the connecting part 10 of the cargo drone 2 with the fastening device 15 on the hanger 3.

Here, the fastening device 15 is formed as a round or angular plug, which can be inserted into an opening in the connecting part 10 adapted to the plug and can snap into the opening.

Also shown here is a weight detecting device 14, which is arranged here on the hanger 3, in particular on the fastening device 15. As usual, this can have strain gauges to determine the weight.

A joint 11 is arranged in the upper region of the connecting part, wherein the joint 11 is designed as a lockable ball joint. Since the ball joint is lockable, a switched off cargo drone 2 can be held on the standing hanger 3 with chair 4 without tipping over.

It is provided to use the passenger drone 1 to transport winter sports enthusiasts 45, in particular with strapped-on winter sports equipment 46.

FIG. 8 shows an exemplary embodiment of a method for transporting winter sports enthusiasts. Shown is a mountainous area suitable for downhill skiing with winter sports equipment 46. In particular, a descent route 43 is suitable for the descent. It is therefore desirable for a winter sports enthusiast 45 to go to the start of the downhill route 43. This could be, for example, a summit.

For this purpose, the at least one winter sports enthusiast 45 is first accommodated in at least one chair 4. The winter sports equipment 46 is preferably at least partially strapped on.

The accommodation of the at least one winter sports enthusiast in the at least one chair 4 can take place in the at least one first base station 321.

The first base station 321 can be, for example, a hut or a lift station. However, the first base station 321 can also simply be the location where the winter sports enthusiast 45 starts with the passenger drone 1.

It may be provided that when at least one winter sports enthusiast 45 is being picked up, the hanger 3 with the at least one chair 4 is separated from the cargo drone 2, and the cargo drone 2 is only connected to the hanger 3 before the at least one winter sports enthusiast is transported. For example, the chairs 4 can be stored at the base station 321 and only picked up by the cargo drone 2 after a winter sports enthusiast 45 has taken his seat.

The hanger 3 with the at least one chair 4 can be provided in the at least one first base station 321 hanging and/or standing on the ground to pick up at least one winter sports enthusiast.

In a next step, the at least one winter sports enthusiast 45 is transported from at least one first base station 321 to an unboarding point 33, preferably located higher than the at least one first base station 321, by, preferably autonomous, flying of the passenger drone 1.

When transporting at least one winter sports enthusiast, the passenger drone 1 can fly autonomously at least in sections or be controlled from the base station 32 or be controlled by at least one winter sports enthusiast 45. The passenger drone 1 can remain within a predefined flight corridor 37 when transporting at least one winter sports enthusiast 45. Flight route 44 is therefore located in flight corridor 37.

In a next step, the at least one winter sports enthusiast 45 is dropped off at the unboarding point 33. In other words, the at least one winter sports enthusiast 45 gets out of the chair 4 of the passenger drone 1. Since the at least one winter sports enthusiast 45 sits in a chair 4 with strapped-on winter sports equipment 46, unboarding is made considerably easier and strapping on the winter sports equipment 46 at the unboarding point 33 is no longer necessary.

The unboarding point 33 may be a point in exposed terrain, such as a summit, a summit ridge or a steep gully.

The unboarding point 33 is located at the beginning of the descent route 43. After the winter sports enthusiast has disembarked/dropped off, the winter sports enthusiast 45 can enjoy the descent along the descent route 43.

The passenger drone 1 can follow the at least one winter sports enthusiast, preferably with the passenger drone 1 sending a warning signal to the base station 32 in the event of an emergency.

Particularly preferably, the at least one winter sports enthusiast can summon the passenger drone 1 away from the at least one base station 32, preferably by means of a mobile transmitting unit. The at least one winter sports enthusiast can then be photographed away from the at least one base station 32, and can then return to the valley or fly again to an unboarding point 33. This means that even downhill routes that are not fully accessible can be partially used.

When the at least one winter sports enthusiast 45 is dropped off at the unboarding point 33, it can be recorded whether the drop-off of the at least one winter sports enthusiast 45 has taken place. The registration can be carried out automatically, in particular by measuring a weight detecting device 14, and/or by manual indication of the at least one winter sports enthusiast 45, and/or by remote indication from the base station 32.

In a next step, the passenger drone 1 can return to the at least one first base station 321. It will then be available for other winter sports enthusiasts 45. Likewise, the passenger drone 1 can wait for the winter sports enthusiast 45 who has just been transported to the unboarding point 33. As shown in FIG. 8, the first base station 321 can be arranged at the end of the descent route 43.

In an exemplary embodiment, an autonomous return of the passenger drone 1 to the at least one first base station 321 or to at least one second base station 322 can be initiated by registering the drop-off of the at least one winter sports enthusiast 45.

FIG. 9 shows a further exemplary embodiment of a method for transporting at least one winter sports enthusiast 45, in particular with strapped-on winter sports equipment 46. Here, the flight corridor 37 is extended.

A first descent route 43 leads from a first unboarding point 33 to the first base station 321, as in FIG. 8. In addition, a winter sports enthusiast 45 can descend from the first unboarding point 33 via a second descent route 43 to a second base station 322. From the second base station 322, the winter sports enthusiast 45 can be transported to a second unboarding point 33, for example on another summit. From there, a winter sports enthusiast 45 can descend via a third descent route 43 back to the second base station 322.

Like the first base station 321, the second base station 322 can be designed as a hut. However, it can also be merely a, possibly predefined, location where a winter sports enthusiast 45 is photographed by a passenger drone 1.

The descent from the second base station 322 to the first base station 311 is not possible in the embodiment of FIG. 9 because cliffs 42 block the way. This means that the departure routes 43 to the second base station 322 can only be used if a passenger drone 1 picks up the winter sports enthusiast 45 from the second base station 322.

As can be seen from FIG. 9, by using passenger drones 1 a kind of flexible, easily modifiable winter sports area can be created. The descent routes, unboarding points and flight routes can be changed daily depending on the avalanche and weather situation.

FIG. 10 shows the connection to a traditional ski area with a chairlift. At least one winter sports enthusiast 45 can be picked up at a valley station 34. The hanger device 3 can initially be attached to the cable 36 of a chairlift 35. The chairlift 35 transports at least one winter sports enthusiast 45 to at least one first base station 321, which is preferably located higher than the valley station 34.

In the first base station 321, which is designed here as a lift station, the hanger 3 is decoupled from the cable 36 of the chairlift 35. This can be accomplished by means of a clamp 16, as with conventional chairlifts 35. Instead of coupling the hanger 3 back to the cable 36 of the chairlift after one circuit, the hanger 3 is coupled to the connecting part 10 of a cargo drone 2. Preferably, the connecting part 10 has a cable section 12, as in FIGS. 6a and 6b. Now the passenger drone 1 can transport the at least one winter sports enthusiast 45 to an unboarding point 33, as shown for example in FIGS. 8 and 9.

This means that only the last part in the impassable, exposed terrain can be covered with the passenger drone 1, while the majority of the route is covered by chairlift. This means that the passenger drone 1 is only used for short distances and can be recharged in the base station 321.

### LIST OF REFERENCE NUMERALS

1 passenger drone
2 cargo drone
3 hanger
4 chair
5 safety bar
6 footrest
7 parking device
8 skid
10 connecting part
11 joint
12 rope section
14 weight detecting device
15 fastening device
16 clamp
17 spring
18 actuating lever
19 rotor
20 cantilever
21 electric motor
22 accumulator
23 sensor
24 position sensor
25 motion sensor
26 environmental sensor
27 control unit
28 communication unit
281 first communication unit
282 second communication unit
29 antenna
30 operator unit
31 intercom
32 base station
321 first base station
322 second base station
33 unboarding point
34 valley station
35 chairlift
36 rope
37 fight corridor
38 chair rod
39 backrest
40 seat
41 base body
12 cliff
43 departure route
11 fight route
45 winter sports enthusiasts
46 winter sports equipment
47 cover
48 protective hood

1. A passenger drone for transporting winter sports enthusiasts with strapped-on winter sports equipment, with a cargo drone, wherein a hanger, can be fastened, preferably in a releasable manner, to the cargo drone, wherein at least one chairlift chair for at least one winter sports enthusiast can be fastened, in particular directly, to the hanger.

2. The passenger drone according to claim 1, wherein a safety bar is arranged and/or fastened to the at least one chair and/or to the hanger.

3. The passenger drone according to claim 1, wherein a footrest is arranged and/or fastened on the at least one chair, preferably on a safety bar arranged on the at least one chair and/or on the hanger.

4. The passenger drone according to claim 1, wherein the hanger has a curved shape at least in sections.

5. The passenger drone according to claim 1, wherein the chair and/or the hanger are/is made at least partially, preferably mostly, from fiber-reinforced plastic, in particular from carbon fiber-reinforced plastic.

6. The passenger drone according to claim 1, wherein the seating area of the at least one chair is at least partially open to the outside and/or is at least partially surrounded by a rod.

7. The passenger drone according to claim 1, wherein the at least one chair can be partially closed by at least one openable, preferably pivotable and/or partially transparent, protective hood, preferably wherein the seating area of the at least one chair is at least partially open to the outside when the protective hood is closed and when it is open.

8. The passenger drone according to claim 1, wherein between the at least one chair and at least one, preferably all, rotors of the cargo drone at least one cover is arranged to protect the winter sports enthusiasts sitting on the at least one chair, preferably wherein the at least one cover
is at least partially transparent, and/or
is curved towards the at least one chair, particularly preferably hemispherical, and/or
is open at the bottom, and/or
is designed as an openable protective hood.

9. The passenger drone according to claim 1, wherein a parking device is arranged on the chair and/or on the hanger, wherein the parking device extends into an area under the at least one chair and/or the hanger, preferably wherein the parking device has at least one skid and/or at least one wheel.

10. The passenger drone according to claim 1, wherein the cargo drone has a connecting part, wherein the hanger can be fastened to the cargo drone by means of the connecting part.

11. The passenger drone according to claim 1, wherein the hanger has a fastening device for connection to the cargo drone at the end opposite the at least one chair.

12. The passenger drone according to claim 1, wherein a preferably lockable joint is arranged between the cargo drone and the hanger, preferably wherein the joint is designed as a hinge, pivot bearing, universal joint or ball joint.

13. The passenger drone according to claim 1, wherein a weight detecting device is arranged between the cargo drone and the hanger, preferably wherein the weight detecting device has strain gauges.

14. The passenger drone according to claim 1, wherein the hanger can be fastened to the cargo drone via a cable section and/or a rail.

15. The passenger drone according to claim 1, wherein the hanger can be fastened to the cargo drone via a clamp, preferably wherein the clamp is held in a closed position by means of a spring and/or can be transferred from a closed position to an open position by means of an actuating lever.

16. The passenger drone according to claim 1, wherein the cargo drone has at least one, preferably four, six, eight or sixteen, rotor(s), wherein the at least one rotor can preferably be fastened to at least one cantilever, and wherein particularly preferably exactly one and/or exactly two rotors can be fastened to each cantilever.

17. The passenger drone according to claim 16, wherein the cargo drone has at least one electric motor, preferably one electric motor per rotor, wherein the at least one electric motor can be supplied with electrical energy by at least one accumulator.

18. The passenger drone according to claim 1, wherein the cargo drone has at least one sensor, preferably wherein the cargo drone
has at least one position sensor, in particular at least one pressure sensor, and/or
at least one motion sensor, in particular at least one gyro sensor and/or acceleration sensor, and/or
at least one environmental sensor, in particular at least one camera, at least one LIDAR system and/or at least one RADAR system.

19. The passenger drone according to claim 1, wherein the cargo drone comprises a control unit for controlling at least one electric motor, wherein the control unit is connectable to sensors.

20. The passenger drone according to claim 1, wherein the passenger drone has at least one communication unit, preferably wherein the communication unit has an antenna for communication, wherein electromagnetic signals can be sent
from a satellite, in particular a navigation satellite, and/or
to and from a mobile and/or stationary transmitting unit, in particular via a
mobile network, and/or received by the same.

21. The passenger drone according to claim 20, wherein a first communication unit is provided in the cargo drone and a second communication unit is provided on the hanger and/or on the at least one chair.

22. The passenger drone according to claim 1, wherein on the at least one chair and/or on the hanger
an operator unit is arranged, wherein the operator unit has a display and/or actuating elements, preferably wherein the cargo drone can be controlled by means of the operator unit, and/or
an intercom system is arranged.

23. The passenger drone according to claim 20, wherein signals can be sent between the communication unit and the operator unit preferably wirelessly.

24. An arrangement comprising at least one passenger drone for transporting winter sports enthusiasts with strapped-on winter sports equipment, with a cargo drone, wherein a hanger can be fastened, preferably in a releasable manner, to the cargo drone, and wherein at least one chair, preferably at least one chairlift chair, for at least one winter sports enthusiast can be fastened, in particular directly, to the hanger, preferably wherein the passenger drone is designed according to claim 1, at least one first base station, and at least one unboarding point (33) located higher than the at least one first base station, wherein the at least one winter sports enthusiast can be transported from the at least one first base station to the unboarding point located higher than the at least one first base station by, preferably autonomous, flying of the passenger drone.

25. A method for transporting winter sports enthusiasts, in particular with strapped-on winter sports equipment, with at least one passenger drone according to claim 1.

26. The method according to claim 25 comprising at least one of the steps:
accommodating at least one winter sports enthusiast in the at least one chair,
transporting the at least one winter sports enthusiast from at least one first base station to an unboarding point, preferably higher than the at least one first base station, by, preferably autonomous, flying of the passenger drone,
dropping off the at least one winter sports enthusiast at the unboarding point,
returning the passenger drone to the at least one first base station or to at least one second base station.

27. The method according to claim 26, wherein at least one winter sports enthusiast is accommodated in the at least one chair in the at least one first base station.

28. The method according to claim 26, wherein when picking up at least one winter sports enthusiast, the hanger with the at least one chair is separated from the cargo drone, and the cargo drone is only connected to the hanger before the transport of the at least one winter sports enthusiast.

29. The method according to claim 26, wherein at least one of the following steps is provided:
picking up at least one winter sports enthusiast in at least one valley station, wherein the hanger is attached to the cable of a chairlift,
transporting the at least one winter sports enthusiast to at least one first base station, preferably higher than the valley station, by the chairlift,
decoupling the hanger from the cable of the chairlift,
fastening the hanger to the cargo drone.

30. The method according to claim 26, wherein the hanger with the at least one chair is provided in the at least one first base station in a hanging and/or standing position on the ground for receiving at least one winter sports enthusiast.

31. The method according to claim 26, wherein the passenger drone remains within a predefined flight corridor when transporting the at least one winter sports enthusiast and/or when returning.

32. The method according to claim 26, wherein the passenger drone during the transport of the at least one winter sports enthusiast and/or during the return, at least in sections,
flies autonomously, and/or
is controlled from a base station, and/or
is controlled by the at least one winter sports enthusiast.

33. The method according to claim 26, wherein when the at least one winter sports enthusiast is dropped off at the unboarding point, it is registered whether the drop-off of the at least one winter sports enthusiast has taken place, preferably wherein the registration takes place
automatically, in particular by measuring a weight detection device, and/or
by manual indication of the at least one winter sports enthusiast, and/or
by remote indication from the base station.

34. The method according to claim 33 wherein an autonomous return of the passenger drone to the at least one first base station or to at least one second base station can be initiated by registering the drop-off of the at least one winter sports enthusiast.

35. The method according to claim 26, wherein the passenger drone follows the at least one winter sports enthusiast before or during the return, preferably wherein the passenger drone sends a warning signal to the base station in the event of an emergency.

36. The method according to claim 25, wherein the at least one winter sports enthusiast can summon the passenger drone away from the at least one base station, preferably by means of a mobile transmitting unit, preferably wherein a recording of the at least one winter sports enthusiast takes place away from the at least one base station.

37. Use of a passenger drone which comprises a cargo drone, wherein a hanger can be fastened, preferably in a releasable manner, to the cargo drone, and at least one chair, preferably at least one chairlift chair, for at least one winter sports enthusiast can be fastened, in particular directly, to the hanger for the transport of winter sports enthusiasts, in particular with strapped-on winter sports equipment, preferably wherein the passenger drone is designed according to claim 1.
